(19) United States
(12) Patent Application Publication
(10) Pub. No.: US 2026/0229971 A1
(43) Pub. Date: Aug. 6, 2026

(54) Drive Motor and Power Tool Having a Drive Motor

(71) Applicant: Robert Bosch GmbH, Stuttgart (DE)

(72) Inventor: Alexander Beljakov, Hardthausen Am Kocher (DE)

(21) Appl. No.: 19/158,333

(22) PCT Filed: Feb. 2, 2024
(86) PCT No.: PCT/EP2024/052582

§ 371 Date: Aug. 20, 2025

(30) Foreign Application Priority Data
Feb. 20, 2023 (DE) 10 2023 201 442.4

(51) Int. Cl. H02K 16/04; B25F 5/00; H02K 7/14

(52) U.S. Cl. CPC H02K 16/04; H02K 7/145; B25F 5/00

(57) ABSTRACT

A drive motor for driving a tool holder of a power tool includes a rotor arranged on a motor shaft, an inner stator and an outer stator. The rotor is arranged in the radial direction of the motor shaft between the inner stator and the outer stator. A first winding is associated with the outer stator for operating at a first voltage level and a second winding is associated with the inner stator for operating at a second voltage level. The first and second voltage levels are different from each other.

### PRIOR ART

The present invention relates to a drive motor for a power tool for driving a tool holder of the power tool.

From the prior art, a drive motor for a power tool having a rotor arranged on a motor shaft and a stator is known.

### DISCLOSURE OF THE INVENTION

The invention relates to a drive motor for a power tool for driving a tool holder of the power tool. A rotor arranged on a motor shaft, an inner stator, and an outer stator are provided, wherein the rotor is arranged in the radial direction of the motor shaft between the inner stator and the outer stator, wherein the outer stator is associated with a first winding for operation at a first voltage level, and the inner stator is associated with a second winding for operating at a second voltage level, and wherein the first and second voltage levels are different from each other.

The invention thus enables the provision of a drive motor in which operation at different voltage levels can be easily facilitated by the arrangement of the rotor between the inner stator and the outer stator.

During operation of the drive motor, preferably the inner stator or the outer stator is powered.

Thus, operation at the first or second voltage level can be easily and straightforwardly facilitated.

Preferably, the inner stator is configured as a DC stator, and the outer stator is configured as an AC stator.

Thus, operation with DC or AC can be facilitated in a simple manner.

Preferably, in a mains operating mode, the outer stator is powered at the first voltage level, in particular a mains voltage, and the inner stator is unpowered.

Safe and reliable operation of the hand-held can thus be made possible with a mains voltage.

Preferably, in a battery mode, the inner stator is powered at the second voltage level, in particular a battery voltage, and the outer stator is unpowered.

Safe and reliable operation of the hand-held can thus be made possible with a battery voltage.

The motor shaft is preferably associated with a decoupling mechanism for decoupling the inner stator or the outer stator in the respectively unpowered state.

Thus, operation with either a mains voltage or a battery voltage can be enabled in a simple manner.

Preferably, the rotor is associated with a magnet carrier having a first magnetic unit associated with the outer stator on its outer circumference and a second magnetic unit associated with the inner stator on its inner circumference.

Thus, a compact rotor can be provided that may be operated in combination with either the outer stator or the inner stator.

Preferably, the inner stator and the outer stator are arranged coaxially with each other.

Thus, an appropriate arrangement of the inner stator and the outer stator can be enabled in a simple and uncomplicated manner.

In addition, the present invention relates to a power tool, in particular a hand-held power tool, having a drive motor as described above.

The invention thus enables the provision of a power tool, in particular a hand-held power tool, with a drive motor, in which operation at different voltage levels can be facilitated in a simple manner by the arrangement of the rotor between the inner stator and the outer stator.

### BRIEF DESCRIPTION OF THE DRAWINGS

The invention is explained in more detail in the following description with reference to the exemplary embodiments shown in the drawings. The figures show:

FIG. 1 a schematic view of a power tool designed as a hand-held power tool with a drive motor according to the invention, and

FIG. 2 a schematic view of the drive motor according to the invention of FIG. 1.

### DESCRIPTION OF THE EXEMPLARY EMBODIMENTS

Elements having the same or a comparable function are provided with the same reference signs in the figures and are described in detail only once.

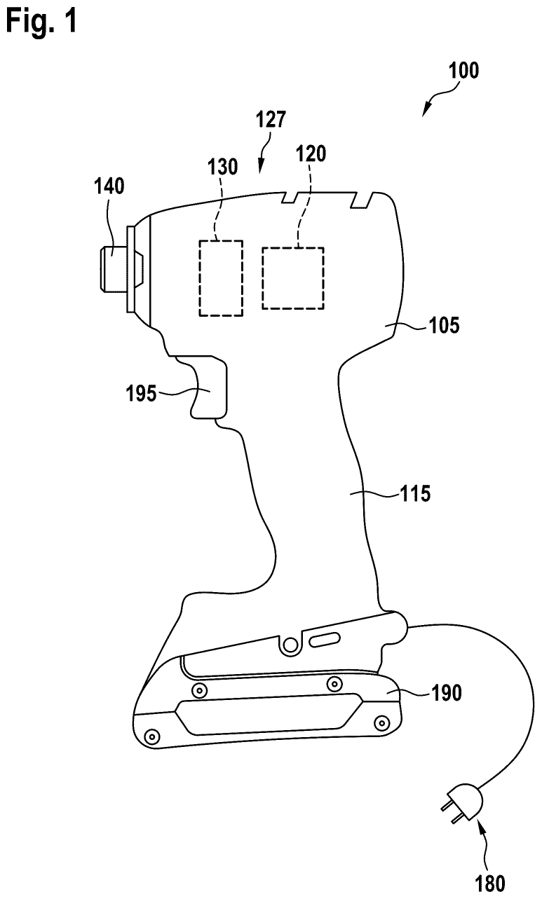

FIG. 1 shows an exemplary power tool 100 designed as a hand-held power tool, which illustratively has a housing 105 having a handle 115. According to one embodiment, the power tool 100 is mechanically and electrically connectable to a battery pack 190 for mains-independent power supply and has a power cable 180 for mains-dependent power supply. The power tool 100 thereby can be operated either independent of the mains or dependent of the mains.

Preferably, a tool holder 140 for receiving an insert tool, e.g. a screwdriver bit, a drill, etc., is associated with the power tool 100. It is noted, however, that the present invention is not limited to hand-held power tools such as screwdrivers, drill hammers, impact wrenches, saws, circular saws, etc., but the power tool 100 may also be configured as a garden tool, electric bicycle, etc.

Illustratively, a drive unit 127 with at least one electric drive motor 120 is arranged in the housing 105. For example, the drive unit 127 is associated with an optional transmission 130.

The drive motor 120 is preferably configured to drive the tool holder 140 and thus an insertion tool arranged therein. The drive motor 120 can be switched on and off, for example, via a manual switch 195.

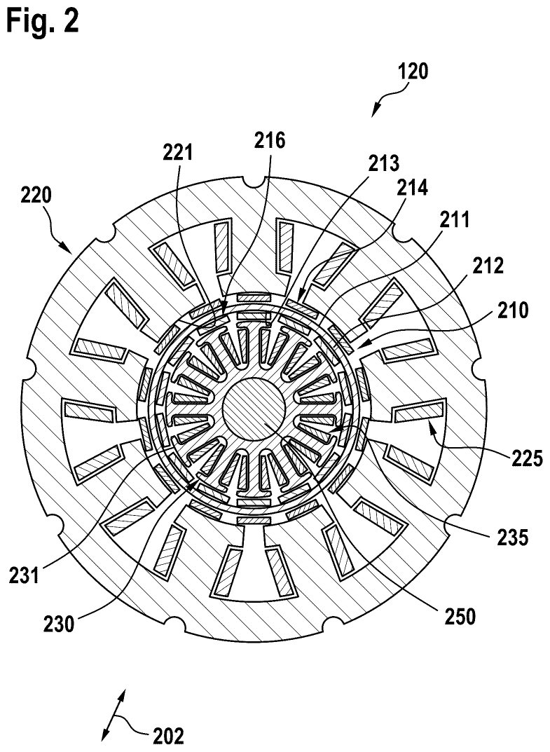

FIG. 2 shows the drive motor 120 of FIG. 1 having a rotor 210 arranged on a motor shaft 250, as well as having an outer stator 220 and an inner stator 230. Preferably, the inner stator 230 and the outer stator 220 are coaxially arranged with each other. The rotor 210 is arranged in the radial direction of the motor shaft 250, or in the radial direction 202 of the drive motor 120, between the inner stator 230 and the outer stator 220.

The rotor 210 is preferably arranged in the radial direction 202 within the outer stator 220. Furthermore, the inner stator 230 is arranged in the radial direction 202 within the rotor 210. In particular, the rotor 210 is illustratively arranged in the radial direction 202 directly between an inner circumference 221 of the outer stator 220 and an outer circumference 231 of the inner stator 230.

According to the present invention, the outer stator 220 is associated with a first winding 225 for operating at a first voltage level. The inner stator 230 is associated with a second winding 235 for operating at a second voltage level. The first and second voltage levels are different from each other.

Preferably, the inner stator 230 is configured as a DC stator and the outer stator 220 is configured as an AC stator. However, the inner stator 230 may also be configured as an AC stator and the outer stator 220 may also be configured as a DC stator.

In operation of the drive motor 120, preferably either the inner stator 230 or the outer stator 220 is powered. As a result, a hybrid DC-AC operation can be enabled.

Preferably, in a mains operating mode, the outer stator 220 is powered at the first voltage level, in particular a mains voltage, via the power cable 180 of FIG. 1, and the inner stator 230 is unpowered. In a battery operating mode, the inner stator 230 is preferably powered at the second voltage level, in particular a battery voltage, via the battery pack 190 of FIG. 1 and the outer stator 220 is unpowered. A voltage level of 36 V can be associated with a corresponding battery voltage, for example, and a voltage level of 230 V can be associated with a corresponding mains voltage, for example.

Preferably, a magnet carrier 212 is associated with the rotor 210. The magnet carrier 212 preferably has a first magnetic unit 214 associated with the outer stator 220 on its outer circumference 211, and has a second magnetic unit 216 associated with the inner stator 230 on its inner circumference 213.

According to one embodiment, the motor shaft 250 is associated with a decoupling mechanism for decoupling the inner stator 230 or the outer stator 220 in the respectively unpowered state. This can prevent a braking of the rotor 210 by the respective unpowered stator when idling.

1. A drive motor for driving a tool holder of a power tool, comprising:
a rotor arranged on a motor shaft;
an inner stator; and
an outer stator,
wherein the rotor is arranged in a radial direction of the motor shaft between the inner stator and the outer stator,
a first winding is associated with the outer stator and is configured for operating at a first voltage level,
wherein a second winding is associated with the inner stator and is configured for operating at a second voltage level, and
wherein the first and second voltage levels are different from each other.

2. The drive motor according to claim 1, wherein, during operation of the drive motor, either the inner stator or the outer stator is powered.

3. The drive motor according to claim 1, wherein the inner stator is configured as a DC stator and the outer stator is configured as an AC stator.

4. The drive motor according to claim 1, wherein, in a mains operating mode, the outer stator is powered at the first voltage level and the inner stator is unpowered.

5. The drive motor according to claim 1, wherein, in a battery operating mode, the inner stator is powered at the second voltage level and the outer stator is unpowered.

6. The drive motor according to claim 1, wherein the motor shaft is associated with a decoupling mechanism configured to decouple the inner stator or the outer stator in a respective unpowered state.

7. The drive motor according to claim 1, wherein:
the rotor is associated with a magnet carrier, which has an outer circumference on which a first magnetic unit associated with the outer stator is arranged, and an inner circumference on which a second magnetic unit associated with the inner stator is arranged.

8. The drive motor according to claim 1, wherein the inner stator and the outer stator are arranged coaxially with each other.

9. A power tool comprising:
the drive motor according to claim 1.

10. The drive motor according to claim 4, wherein, in the mains operating mode, the first voltage level is a mains voltage.

11. The drive motor according to claim 5, wherein, in the battery operating mode, the second voltage level is a battery voltage.

12. The power tool according to claim 9, wherein the power tool is a hand-held power tool.
